(19) United States
(12) Patent Application Publication
(10) Pub. No.: US 2008/0003172 A1
(43) Pub. Date: Jan. 3, 2008

(54) Continuous hydrolysis of hexafluoroarsenic acid

(75) Inventors: Zenart Dziadyk, Lancaster, NY (US); Paul F. Kunkel, Cheektowaga, NY (US); Charles Redmon, Orchard Park, NY (US); Robert Smith, Kinnelon, NJ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/478,467

(22) Filed: Jun. 29, 2006

(51) Int. Cl. C01B 7/19; C01G 28/02

(52) U.S. Cl. 423/484; 423/617

(57) ABSTRACT

Provided is a method for treating an aqueous feed stream containing an admixture of hexafluoroarsenic acid, or any salt thereof, and hydrogen fluoride, by contacting the feed stream with a counter-current stream of steam to remove substantially all of the hydrogen fluoride from the feed stream, and optionally to heat the feed stream. Further, provided is a method for continuously converting hexafluoroarsenic acid in an aqueous admixture, or any salt thereof, into arsenic acid by contacting the admixture with a counter-current stream of steam.

### BACKGROUND

1. Field of Invention

This invention relates to a process for removing fluoroarsenic acids and salts thereof, such as hexafluoarsenic acid and its salts, from aqueous process streams, and to processes for removing hydrogen fluoride from reaction product streams.

2. Description of Related Art

High purity hydrogen fluoride is important for many industries. However, commercial methods of manufacturing hydrogen fluoride typically produce hazardous waste by-products, the disposal of which is problematic. For example, a method generally employed in the manufacture of hydrogen fluoride involves heating a mixture of fluorspar and sulfuric acid in a rotating furnace; see for example commonly assigned U.S. Pat. No. 3,718,736. The crude hydrogen fluoride gases leaving the furnace are scrubbed to remove entrained solids, then cooled and condensed to form an initial crude product. The initial crude product formed, which comprises at least 95 percent by weight of anhydrous hydrogen fluoride, contains various undesirable impurities which are removed by fractional distillation to give technical or industrial grade anhydrous hydrogen fluoride having a purity of 99.95% or better. Yet, the industrial grade anhydrous hydrogen fluoride obtained by this method still contains large quantities of undesirable arsenic impurities which are introduced from the fluorspar starting material. This arsenic material cannot be removed in the distillation process.

The amount of arsenic impurity which is present in industrial grade anhydrous hydrogen fluoride depends in large part on the level of arsenic impurity in the fluorspar from which anhydrous hydrogen fluoride is produced. Industrial grade anhydrous hydrogen fluoride generally contains about 50-500 ppm of arsenic impurity. The presence of arsenic impurity in anhydrous hydrogen fluoride at these levels is highly undesirable for many applications. For example, anhydrous hydrogen fluoride is used in the refining and chemical manufacturing industries, and in such applications even trace amounts of arsenic impurities in the anhydrous hydrogen fluoride can be detrimental. More specifically, arsenic can act as a poison to certain catalysts and can adversely affect the quality of the product being manufactured. As another example, aqueous solutions of hydrogen fluoride are used in the electronics industry as cleaning agents and etchants in the manufacturing of semiconductors, diodes, and transistors. A high degree of purity of anhydrous hydrogen fluoride is required to prevent even minute quantities of arsenic impurity from remaining on the surfaces of the electronic industry products after they have been cleaned or etched with hydrogen fluoride. In addition, arsenic in anhydrous hydrogen fluoride can ultimately cause an environmental problem for the end user.

In many prior processes, the purified anhydrous hydrogen fluoride is separated from the impurities via distillation. These impurities, plus some anhydrous hydrogen fluoride, collect in the bottom of the distillation column. A typical make-up of such bottom mixtures is about 75 to about 95 percent by weight hydrogen fluoride, about 2 to about 20 percent by weight water, up to about 5 percent by weight sulfuric acid, and up to about 5 percent by weight of arsenic acids or salts thereof, for example hexafluoroarsenic acid or one or more salts thereof.

Process streams of the type exemplified by these distilled bottoms streams can be problematic for several reasons. For example, the distillation bottoms frequently contain a substantial amount of unrecovered hydrogen fluoride, which can be valuable and desirable for use in the hydrogen fluoride manufacturing processes or in other processes. It is common, however, that such a process stream contains fluorarsenic acid(s) or salts thereof, such as hexafluoroarsenic acid or salts thereof, which cannot be readily rendered non-hazardous with current stabilization technology. As a result, such process streams have heretofore sometimes been simply disposed of as waste product stream.

Applicants have come to recognize that processes which simply dispose of this or similar streams, without realizing the economic advantage of the hydrogen fluoride present therein, are not as efficient as they could be. This is the case, at least in part, because of an increased demand for purified hydrogen fluoride. For example, hydrogen fluoride is now frequently used in the manufacture of hydrochlorofluorocarbons (HCFCs) and hydrofluorocarbons (HFCs), which are considered to be substitutes for the currently used chlorofluorocarbons suspected of detrimentally affecting the ozone layer. The high demand for HCFCs and HFCs has substantially increased the demand for high purity hydrogen fluoride. As a result, it is desirable to recover as much as possible, preferably substantially all, of the hydrogen fluoride present in process streams which might otherwise be waste streams, such as may occur in connection with the distillation column bottom streams described above.

Furthermore, with respect to disposal of hazardous waste, the fluoroarsenic acid or its salt(s) have, in the United States, heretofore been subject to a stabilization process before disposal can occur. This is required in order to ensure that the waste stream would pass the Toxic Characteristics Leach Procedure Test established by the Environmental Protection Agency (i.e., the waste stream are considered non-hazardous). Other countries often have similar regulations.

One solution is described in commonly assigned U.S. Pat. No. 5,089,241, which is incorporated herein by reference. The '241 patent describes a process for treating a process stream containing hydrogen fluoride and hexafluoroarsenic acid in an aqueous mixture. The treatment process described in the '241 patent has two aspects. First, the process involves acid catalyzed hydrolysis of hexafluoroarsenate to yield arsenic acid and hydrogen fluoride. The arsenic acid and its salts can relatively easily be rendered non-hazardous via further processing. Second, the process includes the step of removing hydrogen fluoride from the reaction mixture (including hydrogen fluoride contained in the column bottoms and the hydrogen fluoride produced via the hydrolysis reaction). The process described in the '241 patent involves adding an acid catalyst, such as sulfuric acid, to an aqueous mixture of hexafluoroarsenic acid and heating the acidic admixture to a temperature sufficient to promote hydrolysis of the hexafluoroarsenic acid. The '241 patent describes the method for removing the hydrogen fluoride from the reaction mixture as passing an inert gas through the heated acid mixture in a quantity sufficient to remove substantially all of the hydrogen fluoride in the heated acid mixture from the heated acid mixture. The patent also notes that the degree and uniformity of mixing of the inert gas with the liquid reaction mixture are factors in determining the amount of inert gas to be used. (Col. 7, ll. 37-40). A preferred inert gas is preferably steam.

The examples of the '241 patent appear to describe a batch-wise hydrolysis operation. Examples 1-4 are described as being carried out in open vessels in which a cross current of air is flowed over the surface of a static liquid reaction mixture (i.e., a liquid mixture that is not subject to a continuous flow) to remove the hydrogen fluoride. Examples 8-18 of the '241 patent describe the use of an inert gas purge to remove hydrogen fluoride from a static liquid mixture. Apparently, an inert gas, such as steam, is added to the acidic admixture and,

after sufficient reaction time, is purged from the reaction batch. In such processes, it appears that at least a portion of the hydrogen fluoride existing in the reaction mixture will leave the reaction mixture with the purged inert gas, thus allowing the hydrolysis reaction to proceed more readily.

While it is possible that the process of the '241 patent has achieved at least a moderate degree of success in achieving its goals, applicants have come to recognize that processes which utilizes an inert gas purge in a static liquid mixture as described in the '241 patent have several significant disadvantages. For example, applicants have discovered that operating a process in this manner requires the use of large quantities of the inert gas, such as steam. These large demands on inert gas supply make the process difficult to control. In the case when steam is used as the inert gas, for example, such large spikes in steam demand make plant water balance difficult to control. Moreover, applicants have come to appreciate that the introduction of inert gas into the reaction mixture in the manner described in the '241 patent produces a hydrogen fluoride product that is of a lower quality than may be desired.

As such, applicants have recognized a need for a process which converts, preferably continuously, a very large proportion (preferably substantially all) of the hazardous hexafluoroarsenic acid and salts thereof in an aqueous process stream to a form that can be rendered non-hazardous, preferably while minimizing the quantity of inert gas, such as steam, which is consumed. Preferably, the process proceeds sufficiently fast and under conditions which are commercially attractive, and also preferably provides for the recovery of the hydrogen fluoride if desired.

### SUMMARY OF THE INVENTION

The present invention relates, in one aspect, to a process for removing fluoroarsenic acid and/or one or more of its salts from an aqueous composition, or alternatively or additionally for removing HF from an aqueous composition, by reacting the composition under conditions effective to convert at least a substantial portion of said fluoroarsenic acid and/or one or more of its salts to at least arsenic acid and hydrogen fluoride, and then preferably removing HF from the composition by exposing the composition to a substantially counter-current flow of inert gas. As used herein, the term countercurrent flow means a system having a first flow with at least a first average vector and a second flow with at least a second average vector, wherein the first and second vectors are in opposite directions. In accordance with one important aspect of the invention, the reaction conditions include removing hydrogen fluoride from the reaction mixture by inducing the liquid reaction mixture to flow generally along a first flow path and causing intimate contact of an inert gas with the flow of reaction mixture liquid by inducing said inert gas to flow substantially along at least a portion of said path but in a direction that is at least perpendicular to, and even more preferably substantially opposite to, the bulk flow direction of the first flow path. As used herein, the term “at least perpendicular” means that the bulk flow direction of the inert gas does not have a positive vector component that is in the same direction as bulk flow path of the reaction mixture liquid. In other words, the bulk flow path of the inert gas preferably can be resolved into a positive direction vector that is perpendicular to the bulk flow path of the reacting components and a positive direction vector that is opposite to the bulk flow path of the reacting components.

In preferred embodiments, the process of removing hydrogen fluoride from the reaction mixture is a substantially continuous process, and even more preferably the process is a substantially continuous process which utilizes a reaction vessel in which the liquid portion of the reaction mixture is made to flow, on average, along a generally defined flow path in a first direction and an inert gas is made to flow along a portion, and preferably a substantial portion, of this path but in a direction which is substantially opposite to the general direction of flow of the reacting components of the reaction mixture. Applicants have found that such a process has significant advantages over inert gas purging operations of the type used in the prior art. Preferably the present processes comprise a substantially continuous process in which a liquid stream comprising hexafluoroarsenic acid, or salt thereof, and hydrogen fluoride is made to flow continuously through a reactor along a first flow path while being exposed to a flow of inert gas which flows, at least in part, substantially counter currently to the flow of said liquid stream. Such a counter current flow in accordance with the present invention, particularly and preferably wherein the inert gas comprises steam, has been found by applicants to more effectively and efficiently remove hydrogen fluoride from the reaction vessel (an hence from the reaction mixture), which in turn improves many characteristics of the reaction process. An example of such effectiveness and efficiency is the chemical gradient that exists in the counter-current flow whereby relatively pure inert gas contacts a liquid mixture of relatively low concentration of impurities thus creating a high driving force for transferring the impurities from the liquid mixture to the inert gas.

In another aspect, the present invention provides a process in which hydrogen fluoride is recovered as a product and/or in which a substantial proportion, and preferably substantially all, of the hexafluoroarsenic acid, or salt thereof, is converted to a material, preferably arsenic acid, or salt thereof, which subsequently can be rendered non-hazardous. That is, in preferred embodiments the arsenic acid, or salt thereof, generated by the reacting step forms water insoluble salts which can be stabilized, preferably by conventional waste disposal technology and then disposed of (such as by being deposited in a land fill or like location) as a non-hazardous waste, or alternatively recovered as part of a product stream. Thus, the conversion of hexafluoroarsenic acid described herein aids in overcoming some of the aforementioned problems, including decreased capacity for higher purity hydrogen fluoride, expensive hazardous waste disposal and potential human exposure to a hazardous waste, and the need for large quantities of inert gas, such as plant steam.

Another aspect of the present invention involves a process for treating an effluent stream from a hydrogen fluoride distillation column, preferably a bottoms stream (e.g., the highest boiling fraction removed from the column), by stripping of the hydrogen fluoride from the stream rather than disposal of the stream with most or all of such hydrogen fluoride still contained in it. In preferred embodiments, the processes include recycling of the stripped hydrogen fluoride to an earlier or upstream unit operation, thereby improving the overall economics of the process.

Another aspect of the present process involves an improvement in one or more of the processes of commonly assigned U.S. Pat. Nos. 4,756,899; 4,929,435; 4,954,330; or 4,032,621, each of which is incorporated by reference, or others. The improvement involves in certain aspects enabling the use of lower cost fluorspar having a high arsenic content as a feed source in such processes.

### BRIEF DESCRIPTION OF THE DRAWINGS

FIG. 1 depicts the use of a packed, counter-current column to separate hydrogen fluoride from a feed stream according to the present invention.

### DETAILED DESCRIPTION OF PREFERRED EMBODIMENTS

Preferred embodiments of the present invention provide a continuous process for separating hydrogen fluoride from an admixture feed stream comprising the steps of (a) providing an aqueous admixture comprising hydrogen fluoride and hexafluoroarsenic acid or a salt thereof; (b) causing said aqueous mixture to flow substantially along a first flow path in a reaction vessel while exposing said aqueous mixture to conditions effective to convert at least a portion of said hexafluoroarsenic acid or a salt thereof to arsenic acid and a salt thereof and hydrogen fluoride; and (c) intimately contacting the aqueous mixture with a flow of inert gas, preferably steam, moving in a generally counter-current direction relative to said first flow path. The counter-current flow of inert gas in accordance with the present invention preferably is highly effective at carrying hydrogen fluoride away from the reaction mixture and from the reaction vessel. Preferably, the counter-current flow of inert gas comprises forcing the inert gas to flow through the liquid in a direction that is generally opposite to the direction of flow of the reaction mixture feed components. As used herein, the term “direction of flow” generally refers to the flow of the material being described in a bulk or average sense and contemplates that at any given point along the flow path one or more molecules of the material in the flow may be moving in a direction that is not along the overall bulk flow path.

According to another aspect of the present invention, provided is a continuous process for converting hexafluoroarsenic acid, or salts thereof, into arsenic acid, or salts thereof, having the steps of (a) providing an aqueous admixture stream comprising hexafluoroarsenic acid or salt thereof, water, hydrogen fluoride, and an acid catalyst; (b) contacting the admixture stream with a counter-current stream of steam; and (c) converting the hexafluoroarsenic acid, or salt thereof, to arsenic acid, or salt thereof.

In preferred embodiments, the present invention treats an aqueous feed stream containing an admixture of hexafluoroarsenic acid, or any salt thereof, and hydrogen fluoride, by contacting the feed stream with a counter-current stream of steam to remove at least about 75% by weight, more preferably at least about 90% by weigh, and even more preferably substantially all of the hydrogen fluoride from the feed stream, and optionally to heat the feed stream. As used herein, the phrase “hexafluoroarsenic acid or salt thereof” refers to the nonvolatile pentavalent arsenic compounds, such as, for example, those described in commonly assigned U.S. Pat. No. 4,756,899 and U.S. Pat. No. 4,929,435. Examples of salts of hexafluoroarsenic acid which may be present in the starting aqueous mixture include, but are not limited to, potassium hexafluoroarsenate (KAsF₆), sodium hexafluoroarsenate (NaAsF₆), ammonium hexafluoroarsenate (NH₄AsF₆), calcium hexafluoroarsenate (Ca(AsF₆)₂) and magnesium hexafluoroarsenate (Mg(AsF₆)₂). Aqueous starting streams according to the present invention may also contain other components, including for example other acids such as sulfuric, phosphoric, fluosilicic, or fluosulfonic; bases such as sodium or potassium hydroxide; or suitable solvents for hexafluoroarsenic acid or salts thereof such as alcohols.

In certain embodiments, the aqueous feed stream comprises at least a portion of an effluent stream from a unit operation such as distillation, preferably the bottom stream from a distillation column, such as the bottoms that results from practicing the process of commonly assigned U.S. Pat. No. 4,756,899 or U.S. Pat. No. 4,929,435, or an aqueous mixture derived from such bottoms, or the like. In general, these streams comprise from about 75 to about 95 percent by weight hydrogen fluoride, from about 2 to about 20 percent by weight water, up to about 5 percent by weight sulfuric acid, and up to about 5 percent by weight hexafluoroarsenic acid or any salt thereof.

According to an aspect of the present invention, provided is process for separating hydrogen fluoride from an aqueous admixture feed stream comprising hydrogen fluoride and hexafluoroarsenic acid, or a salt thereof, by contacting the admixture stream with a steam stream flowing substantially counter-currently with respect to the admixture stream, to separate at least a portion, preferably a substantial portion and even more preferably substantially all of the hydrogen fluoride from the admixture stream. In certain embodiments, the anhydrous hydrogen fluoride stripped from the admixture is formed into a product stream. This product stream may also contain water vapor. The hydrogen fluoride can be either recovered as a product or recycled to a hydrogen fluoride manufacturing process or a combination of these. Recycled hydrogen fluoride subsequently can be recovered and the residual water can be reacted with oleum to form sulfuric acid, which is useful in certain hydrogen fluoride manufacturing processes.

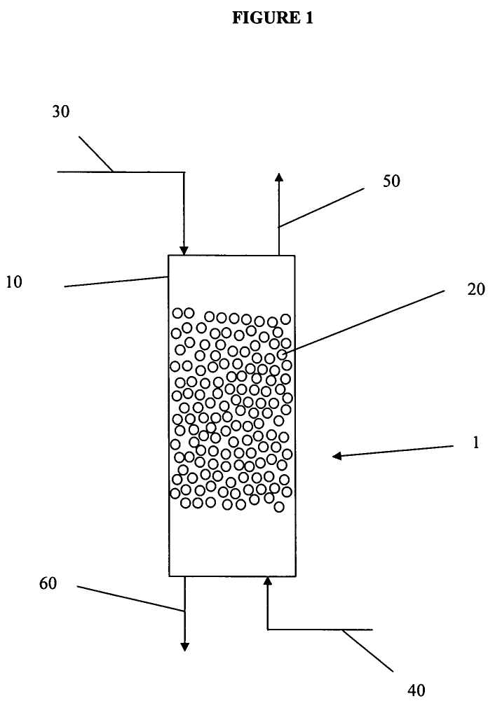

Referring to FIG. 1, shown is a continuous unit operation 1 according to one embodiment of the present invention which utilizes a column, preferably a packed column 10. An admixture stream 30 is preferably introduced into one end of the vessel (e.g., the top of the column and flowing in a bulk sense generally downwards) and steam stream 40 is preferably introduced in the other end f the column (e.g., the bottom of the column flowing in a bulk sense generally upwards). The components of the two streams are thus brought into contact in the packed column 10. While each of the streams are shown herein for simplicity as a single stream, it is contemplated that in certain embodiments it may be desirable to introduce multiple HF containing streams at one or more different locations in the vessel and in one or more different directions of flow and/or to introduce multiple inert gas streams at one or more locations and in one or more different directions of flow into the vessel. It is contemplated within the scope of the present invention in such cases that at least one admixture feed stream is made to flow substantially counter-currently to at least one inert gas stream. The packing and all materials of construction are preferably made of materials impervious to the required heat of any potential reaction process (described in more detail below) and the extremely corrosiveness that can generally be caused by one or more components present in the vessel. An example of a preferred packing material 20 is Goodlow perfluoroalkoxy (PFA) knitted packing. Other examples of preferred materials of construction include PFA tubing and PTFE-lined carbon steel piping; however, the present invention is not limited to any particular type or amount of packing material or type or configuration of vessel.

Preferably, the steam is passed through the vessel in a quantity, at a rate and under conditions sufficient to remove, preferably on a substantially continuous basis, at least about 75% by weight, more preferably at least about 95% by weight, and even more preferably substantially all of the hydrogen fluoride present in the feed stream such that relatively little of the hydrogen fluoride exits the vessel with reaction product stream 60. The product stream 50 exiting the column 10 preferably comprises anhydrous hydrogen fluoride stripped from the admixture, and may also include water vapor. The stripped admixture, or products derived therefrom, exits the column 10 as stream 60. As described in more detail below, this by-product stream 60 preferably comprises arsenic acid derived from the hexafluoroarsenic acid of the admixture feed stream.

The amount of steam to be used in any particular application may vary widely within the scope of the present invention, and it is contemplated that in view of the teachings contained herein those skilled in the art will be able to readily determine the desired amount for any particular application. One important characteristic influencing the selection of the amount of inert gas to be used is the temperature of the inert gas to be used and the desired contact temperature. In certain preferred embodiments, for example with a reaction temperature of from about 140 to about 170° C., it is preferred to use from about 0.5 to about 2.5 pounds of inert gas, preferably steam, per pound of reactants fed to the vessel. In many embodiments, including the particular embodiments described in this paragraph, it is also generally preferred to use from about 10 to about 100, more preferably from about 20 to about 90, pounds of inert gas, preferably steam, per pound of HF contained in the feed to the vessel. In certain embodiments, a process is conducted at a temperature of about 150° C., wherein a minimum of about 8 moles of steam gas, per mole of hydrogen fluoride in the admixture prior to steam addition, is utilized in order to substantially remove all of the hydrogen fluoride. Because the partial pressure of hydrogen fluoride increases with temperature, higher contact temperatures require less steam while lower contact temperatures require more steam. Also, the degree and uniformity of mixing of the steam with the liquid admixture are factors in determining the amount of steam to be used.

In certain preferred embodiments, the steam also supplies heat to the admixture, raising the temperature of components not contained in the steam stream as they pass counter-currently through the vessel. The feed components admixture may also be partially preheated prior to contacting the steam. Preferably, the steam raises the temperature of the admixture to a degree sufficient to aid removal of the preferred amounts of hydrogen fluoride, and preferably substantially all of the hydrogen fluoride, from the feed stream. In certain preferred embodiments, the temperature of the reactant stream components introduced as part of the feed admixture, after contacting the steam and exiting the vessel, is from about 75° C. to about 200° C., and even more preferably from about 130° C. to about 175° C. Applicants have found that it is preferred in many embodiments to use an average process temperature greater than about 75° C. to ensure adequate removal of hydrogen fluoride from the feed stream. On the other hand, applicants believe that the use of average process temperatures of greater than about 200° C. are not preferred since in excess of about this temperature conventional materials of construction for the relevant processing equipment may be damaged or become unfit for their intended purpose.

According to another aspect of the present invention, provided is a continuous process for converting hexafluoroarsenic acid, or salts thereof, into arsenic acid, or salts thereof, having the steps of: (a) providing an aqueous admixture feed stream containing hexafluoroarsenic acid or salt thereof, water, hydrogen fluoride, and an acid catalyst; and (b) contacting said admixture stream with a substantially counter-current flow of inert gas, such as a stream of steam, to produce a product stream comprising a substantial amount of the hydrogen fluoride and a by-product stream comprising arsenic acid or salt thereof.

It is known that commercially available sulfuric, arsenic, or perchloric acid or mixtures thereof can be added to an aqueous mixture comprising hexafluoroarsenic acid, or salt thereof, to catalyze the hydrolysis of the hexafluoroarsenic compound. Hydrolysis of the hexafluoroarsenic compound produces arsenic acid and hydrogen fluoride. Representative hydrolysis reactions according to this process may include:

HAsF₆+4H₂O→H₃AsO₄+6HF

MAsF₆+4H₂O→MH₂AsO₄+6HF

X(AsF₆)₂+8H₂O→X(H₂AsO4)₂+12HF.

wherein M represents monovalent cations and X represents divalent cations and is analogous for multivalent cations.

Mixtures of acids in any proportions may be used and the mixture may be of two or more acids. The preferred acid for certain embodiments of the the present invention is sulfuric acid or arsenic acid.

In certain embodiments, the admixture feed stream is fully or partially preheated before contacting the steam. One reason for preheating the admixture feed stream is to concentrate the hexafluoroarsenic acid, or salt thereof, for a subsequent hydrolysis reaction. Without the preheating step, in certain embodiments the concentration of the hexafluoroarsenic acid or salt thereof could be so low that an undesirably large amount of acid would be required to effectively catalyze the hydrolysis reaction. The use of such additional acid would increase the cost of operation of the process. Preferably, the starting aqueous material has a hexafluoroarsenic acid or salt thereof concentration of about 20 to about 50 percent by weight. If the starting material contains less than this concentration, an evaporation step is preferably used.

For embodiments utilizing an evaporator, the aqueous admixture feed stream is subjected to evaporation so as to concentrate the hexafluoroarsenic acid or salt thereof by removing a portion of the hydrogen fluoride. Preferably, the starting aqueous mixture is heated to a temperature of from about 50° C. to about 150° C. More preferably, the starting aqueous mixture is heated to a temperature of from about 70° C. to about 105° C. The vaporized hydrogen fluoride optionally may be recovered as a product or may be recycled to the beginning of the hydrogen fluoride manufacturing process.

It is also known that hydrogen fluoride and water form an azeotrope when the weight percent of the hydrogen fluoride (based on the total weight of the hydrogen fluoride and water) is at least 38. Thus, for the present reaction, the acid catalyst serves to break this azeotrope, as well as to catalyze the hydrolysis of the hexafluoroarsenic acid or salt thereof.

The amount of acid catalyst present in the admixture is preferably sufficient to break the hydrogen fluoride and water azeotrope and catalyze the reaction, preferably at least about 45 weight percent based on the total weight of the aqueous mixture (including acid catalyst). More preferably, the amount of acid catalyst is about 45 to about 85 weight percent based on the total weight of the aqueous mixture. In certain embodiments, the amount of acid catalyst is present in approximately a 1:1 ratio with the amount of hexafluoroarsenic acid being reacted.

Although the catalytic hydrolysis of hexafluoroarsenic acid, or salt thereof, will partially proceed in the presence of hydrogen fluoride, in order to transform substantially all hexafluoroarsenic acid or salt to arsenic acid or salt, substantially all of the anhydrous hydrogen fluoride must be removed from the reaction mixture.

The contacting the admixture stream with a countercurrent flow of steam effectively removes not only substantially all of the hydrogen fluoride initially present in the admixture, but also removes substantially all of the hydrogen fluoride as it evolves from the reaction. That is, as a portion of the hexafluoroarsenic acid or a salt thereof undergoes hydrolysis in the packed column, hydrogen fluoride evolves. The continuous flow of steam, flowing counter-currently with respect to the flow of the admixture, strips substantially all of the evolving hydrogen fluoride from the admixture, thus allowing the remaining hexafluoroarsenic acid or a salt, which is now substantially free of hydrogen fluoride, to continue undergoing hydrolysis. In certain preferred embodiments, the amount of unconverted hexafluoroarsenic acid present in the by-product stream is less than about 100 ppm, more preferably less than about 50 ppm, and even more preferably less than 10 ppm.

In addition to removing the hydrogen fluoride, the counter-current flow of steam may heat the admixture to maintain a specific reaction temperature. In certain preferred embodiments, the reaction temperature is maintained at from about 145° C. to about 170° C., and more preferably from about 150° C. to about 160° C. However, for certain embodiments, especially those that utilize arsenic acid as an acid catalyst, it is particularly preferably to maintain the reaction temperature at less than 165° C. so that the arsenic acid concentration in the by-product stream does not become too high (i.e., greater than about 80%). A by-product stream having a concentration of arsenic acid greater than about 80% by weight can potentially lead to higher viscosities and the formation of a arsenic pentoxide precipitate.

The resulting product stream of vaporized anhydrous hydrogen fluoride, which may also contain water vapor, and can be recovered as a product or recycled to a hydrogen fluoride manufacturing process.

Preferably, the resulting by-product stream comprises from about 5 to about 25 weight percent arsenic acid or salt thereof, from about 15 to about 40 weight percent water, and from about 45 to about 85 weight percent acid catalyst. More preferably, the resulting mixture comprises about 20 to about 25 weight percent arsenic acid or salt thereof, about 15 to about 25 weight percent water, and about 55 to about 65 weight percent acid catalyst. This mixture may be cooled in order to make the product less corrosive and easier to handle and may be transferred to storage tank for subsequent processing.

The arsenic acid in the by-product stream or from the storage tank may be recovered or this resulting mixture can be rendered nonhazardous by the use of known methods such as discussed by Nancy J. Sell, “Solidifiers for Hazardous Waste Disposal”, Pollution Engineering, 44 (August 1988) and Elio F. Arniella et al., “Solidifying Traps Hazardous Wastes”, Chemical Engineering, 92 (February 1990). Typically, the acid mixture will be converted to a water insoluble salt, such as calcium arsenate, which can then be rendered nonhazardous. For example, this mixture may be reacted with commercially available calcium oxide so as to form the water insoluble calcium arsenate, Ca₃(AsO₄)₂. The reaction which occurs is:

2H₃AsO₄+3CaO→Ca₃(AsO₄)₂+3H₂O

Other calcium or magnesium compounds may also be suitable, provided that the compound supplies calcium or magnesium ions for a reaction with the arsenate. This includes but is not limited to calcium or magnesium hydroxides, chlorides, carbonates, and oxides or combinations such as dolomites including calcium and magnesium carbonate. The mixture may also be reacted with any suitable alkali for neutralization. Cement may then be added in various ratios to solidify and chemically stabilize the insoluble calcium arsenate. When subjected to the EPA Toxic Characteristics Leach Procedure Test, the cement encased calcium arsenate meets the criteria and is considered nonhazardous.

Certain aspects of the invention may be further understood with reference to the following non-limiting examples:

### EXAMPLES

### Comparative Example

The batch process described in U.S. Pat. No. 5,089,241 is utilized to convert hexafluoroarsenic acid to arsenic acid using sulfuric acid.

The aqueous bottoms of a hydrogen fluoride distillation process, which comprise hexafluoroarsenic acid, water, and hydrogen fluoride, are collected and then processed through a flash evaporator to remove a substantial amount of the hydrogen fluoride present. The resulting admixture is then transferred into a 250-gallon, Teflon-lined reactor. Sulfuric acid is added to the reactor in a 1:1 weight ratio with the hexafluoroarsenic acid. The admixture heated to about 125° C. and mixed. This step removes more of the HF from the admixture. Steam at 150 psig is then injected directly into the admixture to heat, agitate, and purge HF from the admixture. The temperature of the reaction admixture is maintained at 150-160° C. The steam purging is continued for 8 hours to convert the hexafluoroarsenic acid to arsenic acid. To insure this specification level is met, the aqueous reaction product is analyzed before transferring the aqueous reaction product to a storage vessel. The analysis of the components of the aqueous reaction product includes the following:

total acid concentration by an acid-base titration;

HF concentration by specific ion electrode with suitable activity buffer;

arsenic acid concentration by iodometric titration;

sulfuric acid concentration by calculating the difference after applying the proper calculation factors (=Total acid−HF−arsenic acid);

water concentration by calculating the difference after applying the proper calculation factors; and

hexafluoroarsenic acid by obtaining sample of the mixture, adjusting the sample's pH, adding a complexing agent, then extracting away from the aqueous solution and spectrophotometrically comparing the extract to a standard curve.

Since the sulfuric acid and water concentrations were measured indirectly, their reported values are approximate. Thus, the aggregate relative concentrations of the individual components does not necessary equally exactly 100%, but instead is approximately 100%.

The total amount of steam used for purging is approximately twice the weight of the material in the reaction mixture and puts a large amount of water into the HF recovery section. It is found that this large volume of steam upsets in the water balance of a corresponding HF production process thereby leading to lower HF product quality.

### Examples 2-4

These examples describe a continuous process for converting hexafluoroarsenic acid to arsenic acid using a counter-current flow of steam.

In each of these examples, a flanged 4″×8′ Teflon-lined carbon steel pipe is used as a reaction column. Dispersion hats were used at the top and bottom of the column to provide good contact between the steam and the reaction mixture and good liquid dispersion over the packing material. The packing material was Glitsch knit PFA (Goodlow) mesh hand packed. All temperature was measured by Teflon coated thermocouples. A differential pressure (dP) transducer was used to monitor/measure the pressure differetial between the top and bottom of the column. The feed heater was a ¼″ PFA tube inside a ¾″ copper tube with 150 pound steam in the annulus. The steam/HF vent cooler was a ¾″ PFA tube inside a 1½″ carbon steel pipe with cold water in the annulus. The product draw was a ¼″ PFA tube inside a ¾″ copper tube with cold water in the annulus. Steam was regulated by a pressure regulator and a manual control valve. Analysis of samples are preformed by procedures similar to those described in the comparative example.

### Example 2

The feed material for the reactor column was made by mixing the hexafluoroarsenic acid, HF and, water mixture with sulfuric acid. This mixture was preheated to 125° C. and then pumped into the top of the column. The steam was concurrently heating the column. The steam rate was measured by condensing the HF and water venting the top of the column and determining the column bottom draw rate for a period of time and then analyzing both samples. As the sulfuric acid and steam mixed, the temperature increased to 150-160° C. and the HF was removed allowing the hydrolysis to go to completion. The process parameters and process results are provided in Table A.

TABLE A

| | Column Feed | Sample 1 | Sample 2 | Sample 3 | Sample 4 |
|---|---|---|---|---|---|
| H₂SO₄ Hydrolysis | | | | | |
| Analysis | | | | | |
| % Tot Acidity (H₂SO₄ | 66.8 | 56.3 | 58.6 | 58.9 | 59.6 |
| equivalent) | | | | | |
| Components: | | | | | |
| % HF | 1.5 | 0.001 | 0.0004 | 0.0003 | 00003 |
| ppm HAsF₆ | | 29 | 5.4 | 4.9 | 1.0 |
| % HAsF₆ | 21.0 | | | | |
| % H₃AsO₄ | 0.27 | 12.6 | 13.2 | 13.4 | 13.2 |
| % H₂SO₄ | 57.4 | 47.6 | 49.5 | 49.7 | 50.5 |
| (Difference) | | | | | |
| % H₂O | 20.1 | 39.4 | 37.3 | 37 | 36.3 |
| (Difference) | | | | | |
| Process Parameters | | | | | |
| Run Time, mins | | 51 | 62 | 72 | 79 |
| Feed Rate, lb/hr | | 6.4 | 6.4 | 6.4 | 6.4 |
| Residence time, mins | | 9 | 9 | 9 | 9 |
| Lbs steam/lb feed | | 1.3 | 1.1 | 0.8 | 0.8 |
| Lbs steam/lb HF in feed | | 87 | 73 | 53 | 53 |
| Column bottom, ° C. | | 135 | 134 | 135 | 135 |
| Column middle, ° C. | | 139 | 140 | 142 | 143 |
| Column top, ° C. | | 157 | 157 | 158 | 158 |
| dP, inches | | 14.4 | 10.2 | 5.3 | 5.4 |

Examples 1 and 2 demonstrate the conversion of hexafluoroarsenic acid or salts to arsenic acid using sulfuric acid to break the HF and water azeotrope. Example 1 is a batch process currently in use. Example 2 is a continuous process with significant improvement in that the reaction time is much shorter and the amount of steam used is about one half of the previous process because of the more intimate mixing of the steam and reaction mixture.

### Example 3

This example demonstrates the use of arsenic acid to break the HF and water azeotrope.

The process of Example 2 is repeated, except that arsenic acid is used as an acid catalyst instead of sulfuric acid, and the feed into the column is maintained at 150-160° C. The process parameters and process results are provided in Table B.

TABLE B

| | Column Feed | Sample 1 | Sample 2 | Sample 3 | Sample 4 |
|---|---|---|---|---|---|
| H₂SO₄ Hydrolysis | | | | | |
| Analysis | | | | | |
| % Tot Acidity (H₂SO₄ | 75.0 | 88.7 | 88.2 | 85.4 | 85.5 |
| equivalent) | | | | | |
| Components: | | | | | |
| % HF | 5.6 | 0.027 | 0.022 | 0.016 | 0.008 |
| ppm HAsF₆ | | 40 | 62 | 6 | 4 |
| % HAsF₆ | 17.4 | | | | |
| % H₃AsO₄ | 53.8 | 90.4 | 88.0 | 84.6 | 84.7 |
| Process Parameters | | | | | |
| Run Time, mins | | 37 | 47 | 22 | 35 |
| Feed Rate, lb/hr | | 3.75 | 3.75 | 3.75 | 3.75 |
| Residence time, mins | | 17 | 17 | 17 | 17 |
| Lbs steam/lb feed | | 1.2 | 1.3 | 1.6 | 1.6 |
| Lbs steam/lb HF in feed | | 21 | 23 | 29 | 29 |
| Column bottom, ° C. | | 145 | 150 | 141 | 148 |
| Column middle, ° C. | | 156 | 154 | 160 | 160 |
| Column top, ° C. | | 144 | 144 | 144 | 144 |
| Feed to Column, ° C. | | 151 | 150 | 156 | 156 |
| dP, inches | | 15.8 | 16.2 | 15.5 | 17.4 |

Example 3 represents a further improvement with respect to the time, steam and sulfuric acid savings of Example 2, and has the added benefit of producing a more concentrated arsenic waste or a marketable product. The arsenic acid produced is suitable but not limited to the wood preservative industry. Runs A and B demonstrate the need for a longer residence time using arsenic acid but the conversion is substantially 100% complete.

### Example 4

This example demonstrates the new process in a continuous mode with recycle of the bottoms draw, after separation of precipitated salt, back through the heater to be mixed with the HF, water and hexafluoroarsenic acid stream (called FEB). Only half of the arsenic acid bottoms were recycled back and mixed with the feed for the continuous process. In the initial startup, however, there would need to be either a supply of previously made arsenic acid or mix sulfuric acid with the feed before recycling and subsequent elimination of the feed sulfuric acid.

The test was run for 1 week, 24 hours a day. These samples were taken over a 42 to 63 hour span and are representative of the whole test. Results are reported in Table C below.

TABLE C

| | Feed | Sple 1 | Sple 2 | Sple 3 | Sple 4 | Sple 5 | Sple 6 |
|---|---|---|---|---|---|---|---|
| Recycle Test | | | | | | | |
| Analysis | | | | | | | |
| % Tot Acid (as | 90 | 87 | 90.2 | 91.2 | 90.1 | 91.5 | 90.9 |
| H3AsO4) | | | | | | | |
| % HF | 3.4 | 0.001 | 0.004 | 0.003 | 0.003 | 0.003 | 0.004 |
| ppm HAsF6 | | 13 | 15 | 17 | 17 | 18 | 23 |
| % HAsF6 | 12.7 | | | | | | |
| % H3AsO4 | 43.7 | 72.3 | 74.7 | 75 | 74.1 | 75.4 | 74.4 |
| Run Conditions | | | | | | | |
| Run Time, hrs | | 42.3 | 47.3 | 50.8 | 53.1 | 57 | 63 |
| Feed FEB, mL/min | | 5 | 8 | 8 | 8 | 8 | 8 |
| Feed Draw, mL/min | | 5 | 8 | 8 | 8 | 8 | 8 |
| Tot Feed, mL/min | | 10.0 | 16.0 | 16.0 | 16.0 | 16.0 | 16.0 |
| Feed Rate, gal/hr | | 0.2 | 0.3 | 0.3 | 0.3 | 0.3 | 0.3 |
| Feed Rate, lb/hr | | 2.3 | 3.7 | 3.7 | 3.7 | 3.7 | 3.7 |
| Residence time, mins | | 18 | | 15 | 15 | 15 | 15 |
| Lbs Vent steam/lb | | 1.1 | | 0.8 | | | |
| feed | | | | | | | |
| Column bottom, ° C. | | 139 | 146 | 143 | 141 | 140 | 141 |
| Column middle, ° C. | | 162 | 156 | 154 | 157 | 154 | 154 |
| Column Top, ° C. | | 152 | 143 | 143 | 142 | 142 | 144 |
| Feed into Col, ° C. | | 166 | 153 | 154 | 154 | 154 | 154 |
| Feed out heater, ° C. | | 71 | 57 | 57 | 57 | 58 | 58 |
| dP, inches | | 15.0 | 15.8 | 16.4 | 17.5 | 16.6 | 14.4 |

Having thus described a several particular embodiments of the invention, various alterations, modifications, and improvements will readily occur to those skilled in the art. Such alterations, modifications, and improvements, as are made obvious by this disclosure, are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A substantially continuous process for separating hydrogen fluoride from a stream comprising at least two components, said process comprising:
(a) causing an aqueous stream comprising hydrogen fluoride and hexafluoroarsenic acid, or a salt thereof, to flow substantially along a first bulk flow path; and
(b) causing a stream comprising inert gas to flow substantially along at least a portion of said first bulk flow path but in a direction that is at least perpendicular to the direction of said first bulk flow path and under conditions effective to remove at least a portion of hydrogen fluoride from said aqueous stream.

2. The process of claim 1 wherein said inert gas is steam.

3. The process of claim 1 further comprising the step:
(c) forming a product steam comprising hydrogen fluoride stripped from said admixture and forming a by-product stream comprising said stripped admixture or reaction product derived therefrom.

4. The process of claim 3 wherein contacting step occurs in a countercurrent flow column.

5. The process of claim 1 wherein said contacting step is preformed at a temperature of from about 75° C. to about 200° C.

6. The process of claim 4, wherein said temperature is from about 130° C. to about 165° C.

7. The process of claim 2 wherein at least a portion of said hydrogen fluoride is derived from the hydrolysis of said hexafluoroarsenic acid or a salt thereof.

8. A continuous process for converting hexafluoroarsenic acid or salts into arsenic acid or salts thereof comprising the steps of:
(a) providing an aqueous admixture stream comprising hexafluoroarsenic acid or salt thereof, water, hydrogen fluoride, and an acid catalyst;
(b) contacting said admixture stream with a counter-current stream of steam to convert at least a portion of said hexafluoroarsenic acid, or salt thereof, to arsenic acid, or salt thereof.

9. The process of claim 8 wherein said converting step involves the hydrolysis of hexafluoroarsenic acid.

10. The process of claim 9 wherein at least a portion of said hydrogen fluoride is derived from the hydrolysis of said hexafluoroarsenic acid or a salt thereof.

11. The process of claim 8 wherein said contacting step strips at least a portion of said hydrogen fluoride from said aqueous mixture.

12. The process of claim 11 further comprising the step of:
(c) forming a product stream comprising hydrogen fluoride stripped from said admixture and a byproduct stream comprising said stripped admixture or a reaction product derived therefrom.

13. The process of claim 12 wherein said byproduct stream comprises arsenic acid, or salt thereof.

14. The process of claim 13 wherein said byproduct stream comprises less than about 100 ppm of hexafluoroarsenic acid.

15. The process of claim 14 wherein said byproduct stream comprises less than about 10 ppm of hexafluoroarsenic acid.

16. The process of claim 13 wherein said byproduct stream comprises less than about 0.1 weight percent hydrogen fluoride.

17. The process of claim 16 wherein said byproduct stream comprises less than about 0.001 weight percent hydrogen fluoride.

18. The process of claim 8 wherein said acid catalyst is present in an amount sufficient to break an azeotrope between said hydrogen fluoride and said water and to catalyze a hydrolysis of said hexafluoroarsenic acid or salt thereof.

19. The process of claim 18 wherein said acid catalyst is selected from the group consisting of sulfuric acid, perchloric acid, arsenic acid, and combinations of two or more of these.

20. The process of claim 18 wherein said acid catalyst is sulfuric acid.

21. The process of claim 18 wherein said acid catalyst is arsenic acid.

22. The process of claim 18 wherein said acid catalyst is present in an amount of at least about 45 weight percent based upon the total weight of the admixture.

23. The process of claim 22 wherein said acid catalyst is present in an amount from about 45 weight percent to about 85 weight percent based upon the total weight of the admixture.

24. The process of claim 18 wherein said acid catalyst is present in about at 1:1 ratio with said hexafluoroarsenic acid.

25. The process of claim 8 wherein said counter-current steam stream heats said admixture via said contacting step.

26. The process of claim 25 wherein said admixture is heated to from about 75° C. to about 200° C.

27. The method of claim 26 wherein said admixture is heated to from about 130° C. to about 165° C.

28. The process of claim 8 wherein a salt of hexafluoroarsenic acid is hydrolyzed.

29. The process of claim 28 wherein said salt is selected from the group consisting of KAsF₆, NaAsF₆, NH₄AsF₆, Ca(AsF₆)₂, and Mg(AsF₆)₂.

30. The process of claim 12 further comprising the step of recovering said hydrogen fluoride from said product stream.

31. The process of claim 12 further comprising the step of recovering said arsenic acid, or salt thereof, from said by-product stream.

32. The process of claim 31 further comprising the step of converting said arsenic acid, or salt thereof, into a water insoluble salt composition that can be rendered non-hazardous.

33. The process of claim 24 wherein said water insoluble salt is calcium arsenate.

34. The process of claim 8 wherein said contacting step occurs in a countercurrent flow-stripping column.
